(19) United States
(12) Patent Application Publication
(10) Pub. No.: US 2011/0012035 A1
(43) Pub. Date: Jan. 20, 2011

(54) Method for Precision Symbolization Using Digital Micromirror Device Technology

(75) Inventor: Matthew D. Romig, Richardson, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 12/503,484

(22) Filed: Jul. 15, 2009

(51) Int. Cl. G21K 5/04

(52) U.S. Cl. 250/492.22

(57) ABSTRACT

A programmed, circuit-controlled digital micro-mirror device (DMD, 202) guides the laser light (201) to create on the surface (211) of an object (210) two-dimensional finely detailed symbolization sets, including bar codes, for a plurality of semiconductor devices (212). The laser light (224) changes a first optical reflectivity of full-field device surface regions to a second optical reflectivity different from and contrasting with the first reflectivity. The programming of the DMD may include time-dependent encrypted codes to shine the laser light onto portions of the two-dimensional surface regions during variable periods of time, creating shadow and three-dimensional effects.

### FIELD OF THE INVENTION

The present invention is related in general to the field of semiconductor devices and processes and more specifically to the structure and fabrication method of packages with fine-line symbolization made with digital micro-mirror devices (DMD) and digital light processors (DLP).

### DESCRIPTION OF RELATED ART

In the process flow of packaging semiconductor chips into complete devices, typically the last step is the symbolization of the device. This step records the information the user needs to know for proper identification and usage of the device. Examples include device type and model, manufacturer, key performance characteristics, and dates. Typical symbolization elements include, numbers, alphabetic letters, trademark symbols, punctuations, arrows, etc. Among the favorite symbolization techniques are stamping with ink for letter sizes as small as 0.8 mm height, and scribing with lasers for letter sizes as small as 0.56 mm height.

In the inking technique, it is the color difference between the ink and the package top surface, which makes the symbolization legible. The color-contrasting ink is deposited on the top package surface, for instance white ink on black epoxy-molded packages. The deposited ink forms heaps or piles on the package surface, deviating from the flatness of the package surface. Among the limitations for reducing the letter sizes are especially the fuzziness at the ink borders and the risk of smearing the ink.

In the laser scribing technique, it is the reflection difference for visible light, which makes the symbolization legible. Laser scribing is especially favored for packages made by plastic compounds, which are commonly fabricated by the transfer molding technique. In the molding technology, the compound is selected to obtain a shiny surface after polymerization so that the surface has good reflection of visible light. The point laser beam is transmitted trough optics into the encapsulation resin of the device, which moves in x- and y-directions under the control of precision galvo motors, to dig grooves into the encapsulation resin, which renders the affected zones with a poor light reflection. In contemporary semiconductor technology, CW Q-switched diode-pumped Nd:Yag lasers for about 20 W output provide spot sizes between 40 and 200 μm at a resolution between 1.7 and 4.4 μm, and the depth of the grooves is typically between about 10 and 90 μm. About 500 characters per second can be written by a single laser head. The cost is approximately $120 k for the laser system and between $160 k and 190 k for the handler. A principal limitation for reducing the letter sizes is the pile-up of the debris along the rims of the laser grooves.

### SUMMARY OF THE INVENTION

Applicant recognized that the ongoing market trend towards smaller and thinner semiconductor components is now demanding packages with symbolization for letter sizes considerably smaller than 0.5 mm height. He further recognizes that the requirement for larger information content of the symbolization will increase in spite of the fact that the available area for symbolization will decrease, resulting in the need for two-dimensional bar codes. International trade and customer bases further desire device inscriptions in the writing systems of foreign languages, for instance finely-structured Chinese characters. Furthermore, the pressure for shorter manufacturing times and lower fabrication costs is likely to increase.

Applicant discovered that the time for laser-inscribing symbolization in the surface area of packages can be reduced by at least one order of magnitude, when today's single-point tool, working on a device on an x-, y-table consecutively line by line across the area, is replaced by a full-field stationary tool, working concurrently across the whole area under the guidance of an encrypted code. In addition, applicant saw the advantage of introducing shades into the symbolization rather than just on-off options, together with a method for producing the shades by operating the encrypted code of the full-field tool in a time-dependent mode.

Applicant solved the problems of shrinking letter sizes, finely detailed symbols, and two-dimensional bar codes, in the symbolization by implementing circuit-controlled digital micro-mirror devices (DMD) as the guiding control for laser light. In addition, using a DMD as a guiding tool permits the inscription of a whole two-dimensional symbolization set, including bar codes, resulting in faster fabrication cycles. Furthermore, the high number of micro-mirrors in a DMD further offers simultaneous inscriptions in a plurality of devices or device areas, resulting in batch processing and high production throughput.

An unexpected benefit of the use of a DMD as laser control unit is the possibility to regulate the micro-mirrors in a time-variable mode, offering a new degree of freedom to create shaded symbolization for simulating the impression of three-dimensional contrast. An additional level of information can be encoded in the symbolization. Further, when suitable compounds are used as packaging materials, the various levels in inscriptions can be employed for encoding colors in the symbolization.

One preferred embodiment of the invention is a digital multi-mirror device operating in conjunction with a powerful collimated laser; the symbolization can be performed at unit level or at block level (batch processing). In another embodiment, the DMD operates in conjunction with ultra-violet light to increase the effect of transforming the surface appearance of polymeric materials.

The application of collimated laser light and UV light controlled by DMD can be expanded to other process steps in the assembly and packaging flow of semiconductor devices. An example is the process step of UV tape release after the sawing operation and after solder ball attachment. Another example is a snap cure process of a polymer material. Yet another example is the patterning of substrates, replacing the commonly used methods of photolithography or laser direct imaging.

### BRIEF DESCRIPTION OF THE DRAWINGS

FIG. 1 shows an exemplary schematic equipment layout including light source (laser, UV), optics, digital micro-mirror device (DMD), and device-to-be-symbolized to fabricate a programmable, miniaturized full-field two-dimensional symbolization on the device surface.

FIG. 2 illustrates an exemplary schematic equipment layout including light source (laser, UV), optics, digital micro-mirror device (DMD), and device-to-be-symbolized to fabricate programmable, miniaturized full-field two-dimensional symbolizations on the surfaces of a plurality of devices.

### DETAILED DESCRIPTION OF THE PREFERRED EMBODIMENTS

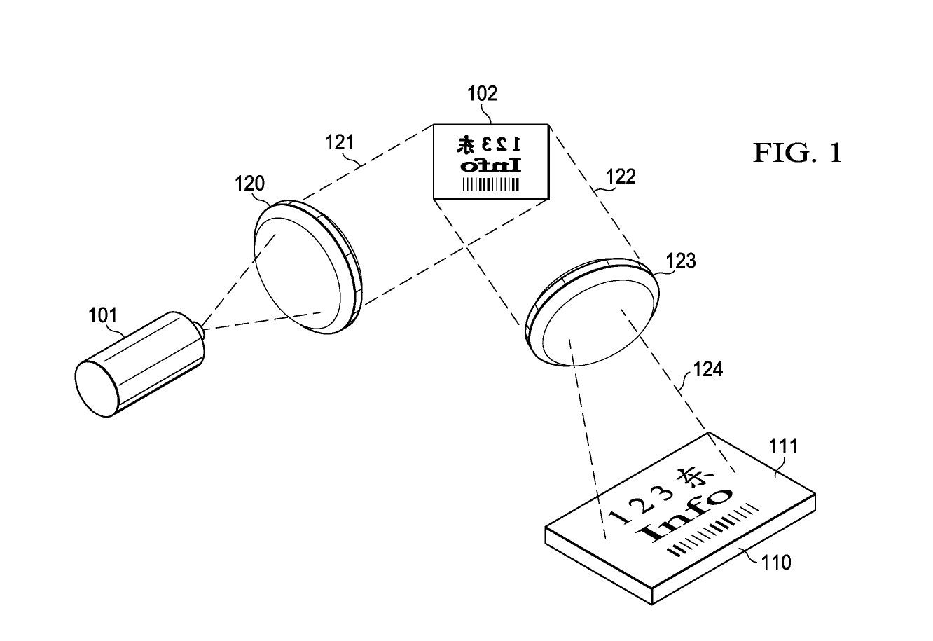

FIG. 1 shows an exemplary arrangement of equipments 101 and 102 to convey onto the surface 111 of an object 110 the information needed to identify and characterize the object. Since this information may include items such as numbers, alphabetic letters, writing characters, trademark symbols, punctuations, and arrows, it is generally referred to as symbolization. The arrangement of the equipments in FIG. 1 is preferably intended to produce the miniaturized symbolization on the surface 111 of semiconductor devices 110, which are available in a wide spectrum of sizes, usually with rectangular or square outline. Alternatively, surface 111 may be the surface of any object 110, which needs a characterization through symbolization. While the side length of some devices may be larger than 10 mm, some units have side lengths on the order of only 1 mm. Alternatively, object 110 may be any object with a solid surface in need of symbolization.

In the preferred embodiment, equipment 101 is a light source, such as a laser or an ultraviolet light source, and equipment 102 is a digital micro-mirror device (DMD). A suitable laser example is a CW Q-switched diode-pumped Nd:Yag laser (neodymium:yttrium-aluminum-garnet crystal, wavelength 1064 nm, Q-switch frequency 70 kHz) for 100 W total power and about 20 W output power (such as Electro Optics SLD 402). In the preferred embodiment, equipment 102 is a digital micro-mirror device (DMD) such a digital light processor (DLP™, by Texas Instruments, USA, for instance a component of the X1076-714 series, the X1076-716 series, the X1076-729 series, or the X1076-740 series).

As FIG. 1 illustrates, the preferred embodiment includes optics 120 between light source 101 and DMD 102, and optics 123 between DMD 102 and object 110. Optics 120 collimates the light (121), and optics 123 transforms parallel light 122 into divergent or convergent light 124. Alternatively, optics 120 and 121 may be omitted; the light from source 101 is then used by DMD 102 directly and transmitted from DMD 102 to object 110 directly.

DMDs are transducers that modulate incident light in a special pattern pursuant to the programming by an electrical or other input. The incident light may be modulated in phase, intensity, polarization or direction. DMDs thus include micromechanical arrays of electronically addressable mirror elements or pixels, which are selectively movable or deformable. Each mirror element is movable in response to an electrical input to an integrated addressing circuit formed monolithically with the addressable mirror elements in a common substrate. Incident light is modulated in direction and/or phase by reflection from each element.

DMDs using beams include torsion beam DMDs, cantilever beam DMDs, and flexure beam DMDs. Each movable mirror element of all three types of beam DMD includes a relatively thick metal reflector supported in a normal, undeflected position by an integral, relatively thin metal beam. In the normal position, the reflector is spaced from a substrate-supported, underlying control electrode, which may have a voltage selectively impressed thereon by the addressing circuit.

When the programming of the DMD causes the control electrode to carry an appropriate voltage, the reflector is electrostatically attracted thereto and moves or is deflected out of the normal position toward the control electrode and the substrate (time constant on the order of 10 to 15 μs). Such movement or deflection of the reflector causes deformation of its supporting beam storing therein potential energy which tends to return the reflector to its normal position when the control electrode is de-energized. The deformation of a cantilever beam comprises bending about an axis normal to the beam's axis. The deformation of a torsion beam comprises deformation by twisting about an axis parallel to the beam's axis. The deformation of a flexure beam, which is a relatively long cantilever beam connected to the reflector by a relatively short torsion beam, comprises both types of deformation, permitting the reflector to move in piston-like fashion. A typical DMD includes an array of numerous pixels (on the order of 0.5 to 1 million), the reflectors of each of which are selectively positioned to reflect or not to reflect light to a desired site.

After light source 101, DMD 102 and device-to-be-symbolized 110 are positioned as schematically indicated in FIG. 1, the array of mirrors in DMD 102 is configured in the pattern desired to perform the symbolization of device 110. At the outset, the surface 111 of device 110 has a first optical reflectivity. In the process of creating a symbolization on the surface 111, selected surface regions are illuminated by light from light source 101 (for instance, intense laser light) for a period of time so that the first optical reflectivity is changed to a second optical reflectivity, which is different from and contrasting with the first reflectivity.

The integrated circuitry, which controls the micro-mirrors of DMD 102, is programmed to encrypt the code of the intended full-field two-dimensional symbolization. Wherever activated, the mirrors are set to a position called “on” to reflect light onto surface 111. Wherever not activated, the mirrors are set to a position “off” and no light is reflected onto surface 111. The fine resolution of the array of mirrors (pixels) in the DMD 102 allows for a very high level of resolution of the symbolization, which may include any numbers, alphabetic letters and foreign characters (such as mathematical, Chinese, and Arabic characters), trademark symbols, punctuations, arrows, drawings, and two-dimensional bar codes.

The act of changing the optical reflectivity includes diverse processes, dependent on the power and exposure time of the light, especially high-energy laser light. The change in reflectivity may caused by three-dimensional contours in the surface, for example by grooves of a certain depth and width. As an example, the grooves cut into the flat and shiny surface of polymerized epoxy-based molding compounds create a matte appearance, clearly identifiable with the unaided eye of an inspector (or under the microscope for miniaturized dimensions). Alternatively, the change in reflectivity may be caused by chemical burn process without significantly changing the flatness of the surface. Or the energy of the light may initiate a chemical reaction so that the reflectivity or color of the affected region is changed, resulting in a visual contrast to the unaffected original surface.

The two-dimensional layout of the micro-mirrors allows the concurrent symbolization across the whole two-dimensional device surface 111 based on the encrypted on-off mirror positions. In addition, the possibility to program a time-dependent mode into the encrypted code, the light may shine for variable periods of time on selected surface regions. As a consequence, the change of optical reflectivity may assume interim values between complete on or off. Values of “shadows” or three-dimensional appearances may thus be included in the symbolization.

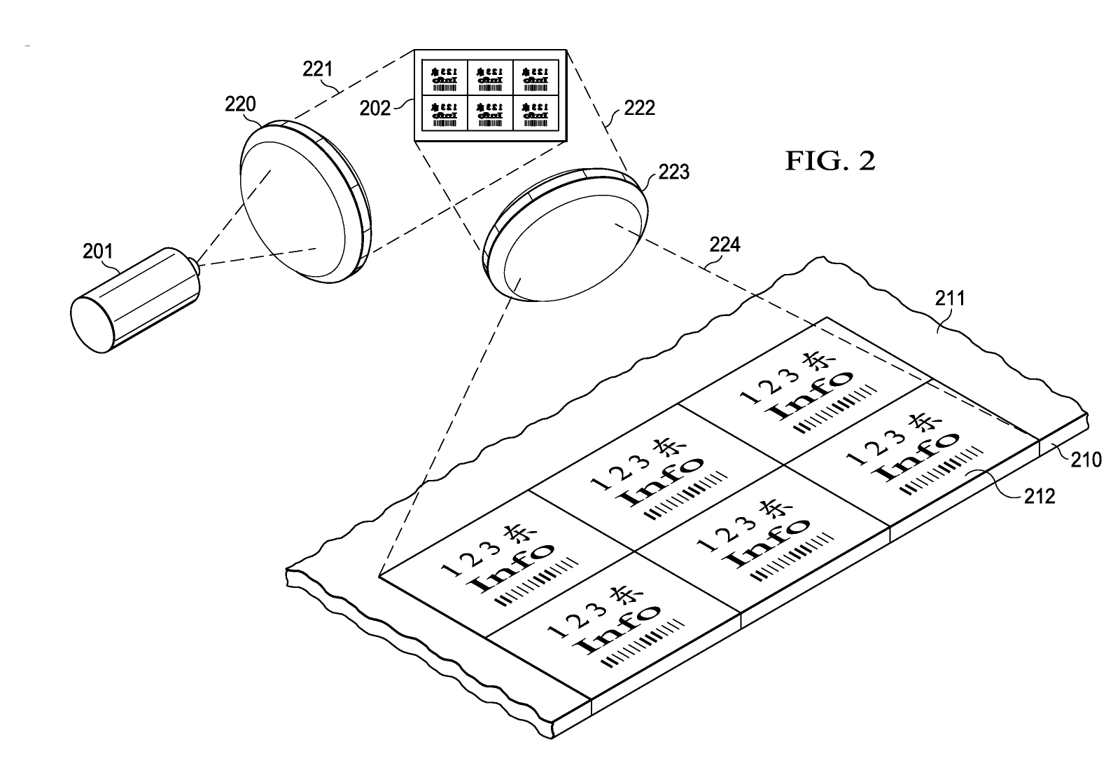

Another exemplary embodiment of the invention is depicted in FIG. 2. Equipment 201 is a light source such as a diode-pumped laser with an output power of about 20 W. Equipment 202 is a programmable DMD such as a digital light processor DLP™. The object 210 is an array of objects such as a plurality of packaged semiconductor devices 212, which still form a continuous group before singulation. Object 210 has a surface 211 of a first optical reflectivity, which includes the surface of the individual devices in need to be symbolized for receiving the information to identify and characterize the devices. In the process of symbolization, full filed two-dimensional regions of the first optical reflectivity are changed to a second optical reflectivity different from and contrasting with the first reflectivity.

In the example of FIG. 2, the DMD has been programmed so that the array of mirrors is configured in the pattern required to perform the symbolization of all devices concurrently. The code encrypted in DMD 202 thus allows creating the full-field two-dimensional symbolization of the plurality of devices 212 in a batch process, resulting in a high throughput and low cost manufacturing method. The optics 220 between light source 201 and DMD 202 collimates the light 221; the optics 223 between DMD 202 and object 210 transforms parallel light 222 into divergent light 224. In an alternative arrangement of the equipments, optics 220 and 223 may be omitted.

As stated above, dependent on the nature of surface 211 and the energy and illumination time of laser 201, the change of reflectivity of the two-dimensional regions of surface 211 and the visual contrast between the regions may be caused by three-dimensional contours, such as grooves, produced in the originally flat surface; or by a chemical burn process without significant change in the flatness of the surface; or by a chemical reaction initiating a color change or reflectivity change. The change of reflectivity and contrast is created at the same time across the entire two-dimensional field of the object, and is exactly determined by the array of programmed mirrors. The time required for the symbolization process, for example the depth and contrast of an ablation process, may vary from a fraction of a second to several seconds dependent on the power of the laser and the nature of the surface material.

The programming of the two-dimensional region of the DMD may include a time-variable, or time-dependent code for some mirrors. As a consequence, varied levels of ablation and contrast may be created, producing symbolizations with seemingly shadow-like or three-dimensional appearance.

While this invention has been described in reference to illustrative embodiments, this description is not intended to be construed in a limiting sense. Various modifications and combinations of the illustrative embodiments, as well as other embodiments of the invention, will be apparent to persons skilled in the art upon reference to the description. As an example, the invention applies to any type of packaged semiconductor device, discrete or integrated circuit, and the material of the package may include polymeric compounds, inorganic encapsulations or any other packaging material used semiconductor manufacturing.

As another example, the invention applies also to devices, wherein a laser pulse may cause a bulging of the illuminated surface regions with a bulge height sufficient to cause a contrast in the surface reflectivity between the before and after exposure regions. The size of a symbol achievable with the invention may be much smaller (<<0.1 mm) than achievable by conventional technology.

As another example, the invention applies to any surface with a first optical reflectivity, where thermal energy with a programmable two-dimensional distribution can produce two-dimensional regions of a second optical reflectivity different from and contrasting with the first reflectivity. Such surfaces may be found in FR-4 boards, parts made of thermoset compounds, ceramic plates, and metallic objects.

It is therefore intended that the appended claims encompass any such modifications or embodiments.

I claim:

1. A method for symbolizing a semiconductor device comprising the step of:
changing by laser light having a programmable two-dimensional distribution, a first optical reflectivity of a full-field device surface region to a second optical reflectivity different from and contrasting with the first reflectivity.

2. The method of claim 1 further including, prior to the step of changing, the step of programming the circuitry of a digital micro-mirror device (DMD) to encrypt the code of a full-field two-dimensional symbolization including bar codes for the semiconductor device.

3. The method of claim 2 further including, after the step of programming and before the step of changing, the step of collimating a laser, the programmed DMD, and the surface of the device so that the focused laser light is directed by the programmed micro-mirrors onto the device surface regions selected by the encrypted code.

4. The method of claim 2 further including the step of programming a time-dependent mode into the encrypted code to shine the laser light onto portions of the two-dimensional surface region during variable periods of time, resulting in varying levels of contrast (grayscale).

5. The method of claim 2 further including the step of programming the circuitry of a digital micro-mirror device (DMD) to encrypt the code of a plurality of full-field two-dimensional symbolizations for a plurality of semiconductor devices.
